(19) United States
(12) Patent Application Publication
(10) Pub. No.: US 2006/0083181 A1
(43) Pub. Date: Apr. 20, 2006

(54) Method, an access point, a telecommunication device, a server and an information system for providing and for retrieving within a telecommunication network available network connection types

(75) Inventors: Jens Gebert, Oberstenfeld (DE); Rolf Sigle, Remshalden (DE); Bertrand Lapraye, Gif-sur-Yvette (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/233,118

(22) Filed: Sep. 23, 2005

(30) Foreign Application Priority Data
Oct. 20, 2004 (EP) 04292496.9

(51) Int. Cl. H04L 12/28; H04Q 7/00

(52) U.S. Cl. 370/254; 370/328

(57) ABSTRACT

A method for retrieving within a telecommunication network available network connection types at a given location provided by access points by means of a telecommunication network device (M), where the available network connection types at a given location are stored in an information system, the telecommunication network device (M) establishes at least one connection towards said information system, and queries for available network connection types using the given location.

And a method for providing within a telecommunication network available network connection types at a given location provided by access points by means of a telecommunication network device, where an access points provides its coverage (C1, . . . , C5) and its connection type in an information system for retrieving available network connection types. The invention further relates to a server, an information system, a telecommunication device, and an access point.

### TECHNICAL FIELD

The present invention relates to methods for providing and for retrieving within a telecommunication network available network connection types, especially for wireless telecommunication networks. The invention further relates to a server, an information system, a telecommunication device, and an access point.

The invention is based on a priority application, EP 04292496.9, which is hereby incorporated by reference.

### BACKGROUND OF THE INVENTION

Today's mobiles and in general all radio networking devices provide a plurality of connection types comprising a certain media diversity like optical interfaces as well as radio interfaces, as well as several standardized wireless access technologies, e.g. Bluetooth, GSM (Global System for Mobile communications), GPRS (General Packet Radio Service), UMTS (Universal Mobile Telecommunications System), WiFi (Wireless Fidelity), WiMAX (Worldwide Interoperability for Microwave Access), etc.

All these mobile devices share a common property. For instance within UMTS, after switching on, the user equipment, the terminology for a mobile in UMTS, selects a Public Land Mobile Network (PLMN), then a cell, and after that it performs a location registration, see e.g. 3GPP TS 25.304 “UE procedures in Idle Mode and Procedures for Cell Reselection in Connected Mode”. In 3GPP TS 23.122 “NAS Functions related to Mobile Station (MS) in idle mode” the mobile station seeks a suitable cell of the chosen PLMN and chooses that cell to provide available services, and tunes to its control channel. Within another technology, the WiFi, ANSI/IEEE Std 802.11, 1999 Edition “Information technology—Telecommunications and information exchange between systems—Local and metropolitan area networks—Specific requirements—Part 11: Wireless LAN Medium Access Control (MAC) and Physical Layer (PHY) Specifications” describes two methods of scanning: active and passive scanning, are specified. IEEE 802.11b defines more details on the scanning for connections, e.g. scan 13 possible channels in Europe, scan 11 channels in USA, etc.

U.S. Pat. No. 5,950,130 discloses a method of intelligent roaming wherein a Systems Access List (SAL), programmed into the memory of a mobile station over-the-air or via a physical interface, is used to select a preferred system for service. When the mobile station is powered on, it scans the home band first, then a secondary band if a control channel is not found on the home band. If the mobile station determines that it is located in its home system, it remains on that band and obtains service from the home system. If the mobile station is not located within its home system, the SAL is searched to determine if there is a preferred system in the same area as the current system. If not, then the mobile station obtains service on the current system. If the SAL indicates there is a preferred system in the same area as the current system, then the SAL also indicates the exact band(s) where a preferred system may be located. The SAL may include information on the blocks of channels to scan. The SAL may indicate the air interface technology supported on each of the preferred bands, to assist the mobile station in finding a system of a given technology type.

For the inter-working between a wireless local area network (WLAN) and UMTS, information is provided in a UMTS broadcast channel to indicate the availability of WLAN access.

In order to cope with different radio access technologies and access, in general access connection types, scanning is applied.

Throughout this application, “connection type” is understood to subsume any kind of standard for access technology, regardless of the bandwidth, the medium, i.e. radio or infra red or optical, the coding, the technology etc. The access point is understood to subsume any kind of network connection providing an access unit like a base station, a node B, a WiFi access node, a Bluetooth node etc.

In the future, mobiles have to cope with an increasing number of available access types. Today's mobiles even support a variety of access technologies. When applying the current scanning solution, outlined above as an example, the mobile has to scan for instance the radio coverage available on any of these radio technologies. This scanning on each e.g. radio interface is time and energy consuming, which leads to a reduction of the standby time and phone-time of a battery-powered mobile phone.

The problem is a fast and effective retrieval of possibly available access technologies at a given location.

This problem is solved by a method for retrieving within a telecommunication network available network connection types at a given location provided by access points by means of a telecommunication network device, where the available network connection types at a given location are stored in an information system, the telecommunication network device establishing at least one connection towards said information system, and queries for available network connection types using the given location.

And the problem is solved by a method for providing within a telecommunication network available network connection types at a given location provided by access points, where an access point provides its location and its provided connection type in an information system for retrieving available network connection types for a given location.

And the problem is solved by an information system comprising a server, comprising means for storing available network connection types per location, for retrieving and providing within a telecommunication network available network connection types according to the above methods.

An access point comprising means for providing its location correspondingly solves the problem and its provided connection type to an information system for retrieving available network connection types for a given location.

And a telecommunication device comprising means for retrieving within a telecommunication network available network connection types solves the problem.

In other words, the problem is solved by a collaboration, i.e. to retrieve a list of available access technologies, i.e. available connection types, for a given geographical location or position using a technology independent information system that might be realized by a distributed database.

A mobile (access) device requires at least one connection of a first initial type, e.g. GPRS, towards the information system. The position information of the mobile is provided to the information system. This information might be rendered by GPS (global positioning system) or as an attribute of the initial connection, e.g. a cell number of the GPRS network. The information system retrieves potential access technologies, i.e. connection types provided by other (available) access points covering the provided position.

Each access point, e.g. a base station, a node B, a mobile relay, etc. can update the database of the information system with its location, coverage area and/or covered locations, supported access technologies and optionally additional parameters about the access technology. These updates are uniformly treated as (potential) connection type.

Additional parameters can contain for example information about used frequencies, channels, spreading codes, broadcast channel identifiers, . . .

The form of a query might not even be strictly location- or position-based but instead lazy, e.g. find all connection types within a certain area, e.g. a neighboring location, or find all connection types where there is an intersection with the coverage of the current (initial) access point.

The response might contain a list of possibly available radio access technologies at that location and optionally the above described additional parameters.

This information can be used for mobility management and handover decisions.

Preferably efficient distributed databases are used as information system to store the connection type information per location. The database structure (or scheme) preferably reflects the physical (location) arrangement homomorphical.

In a special realization of this invention, the domain name system (DNS) might be used as database, where the geographical position or even the coverage is presented as a domain name. A terminal or network element can identify the available access points by domain names corresponding to the (given) geographical position.

### SUMMARY OF THE INVENTION

Accordingly, it is an object and advantage of the present invention to avoid the scanning effort for identifying all possible access technologies, i.e. seeking on all frequencies, trying different sets of parameters, etc. which is time- and energy-consuming.

Another advantage of the present invention is to provide an efficient retrieval by decomposing the whole information of global coverage—which is large—into small local parts carrying the neighboring environment The resulting scalability and the overall performance of the system can even be improved when using distributed databases. At least one connection to the network is necessary to use the database. And such a connection might even be standardized in order to avoid each and every scanning.

A further advantage of the present invention is the uniformity, of the approach, i.e. suited for the diversity of known wireless access network types. It applies and is intended to all kind of wireless connection technologies and types.

### BRIEF DESCRIPTION OF THE DRAWINGS

These and many other objects and advantages of the present invention will become apparent to those of ordinary skill in the art from a consideration of the drawings and ensuing description, where

FIG. 1 is a schematic drawing of an access network environment showing access nodes and a telecommunication device according to the invention.

FIG. 2 shows a schematic drawing of information maintained in the information system according to the methods of the invention.

FIG. 3 shows a schematic drawing of relevant information for the telecommunication device according to the invention.

FIG. 4 illustrate the collaboration according to the method for providing within a telecommunication network available network connection types according to the invention.

FIG. 5 illustrates the collaboration according to the method for retrieving within a telecommunication network available network connection types according to the invention.

Those of ordinary skill in the art will realize that the following description of the present invention is illustrative only and is not intended to be in any way limiting. Other embodiments of the invention will readily suggest themselves to such skilled persons from an examination of the disclosure.

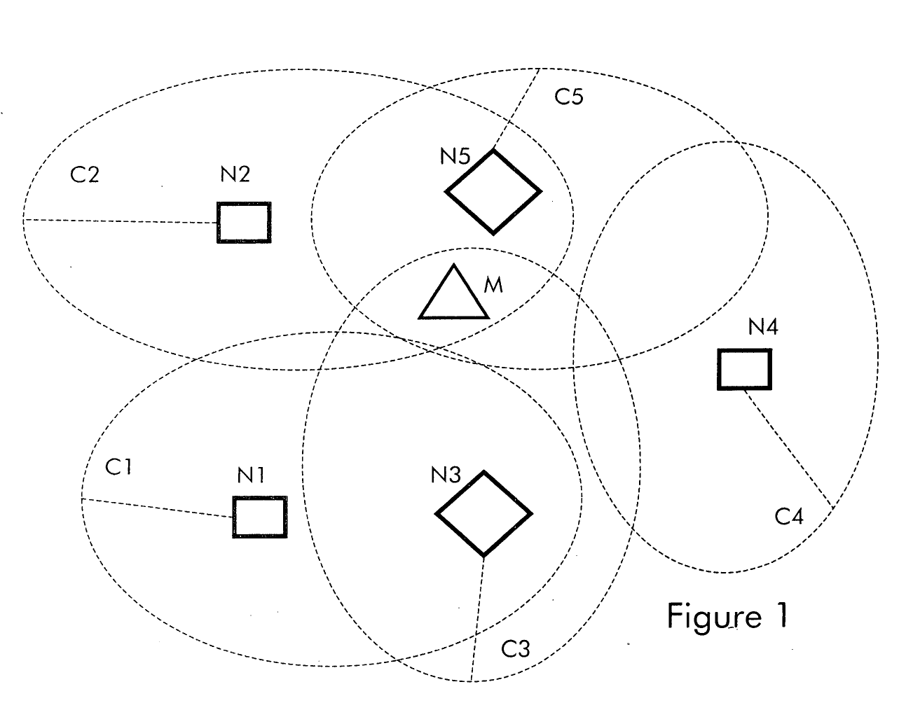

FIG. 1 shows a schematic view of a (radio) access network comprising five access nodes N1, . . . , N5 of two types, shown by squares. Each access node N1, . . . , N5 has for reasons of simplicity an elliptic coverage C1, . . . , C5, respectively, shown by the dashed line with its access node linked to an ellipse. The figure also shows a telecommunication device M, a mobile, say. The mobile is in the coverage of a certain subset of the access nodes, namely N5, N2, and N3. It is outside the coverage of N1 and N4.

When the mobile is within the coverage of an access node it is able to establish a connection with that access node. To identify a reachable access node, i.e. an access node having a coverage that overlaps (or covers) the mobiles position.

In the prior art this is done by scanning the communication media for certain signals.

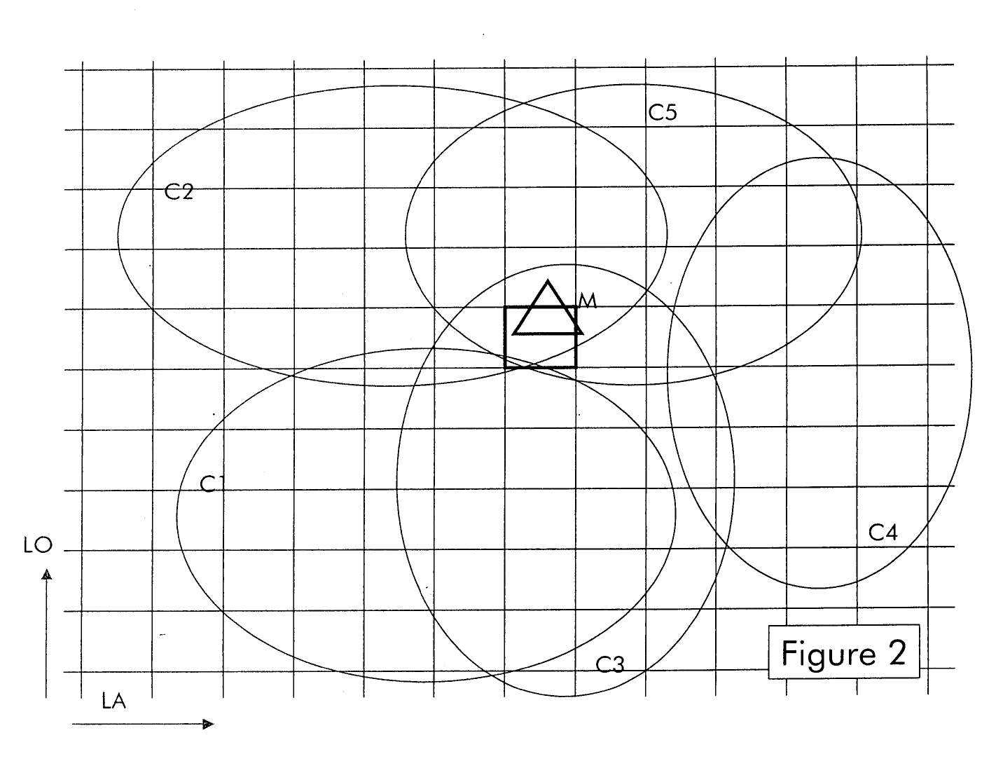

FIG. 2 illustrates a representation of the coverage information shown in FIG. 1. For reasons of simplicity, a two-dimensional Cartesian coordinate system is assumed as coverage space. Any (uniform) coordinate system reflecting the physical topology of the access point coverage is suited for that purpose. The shown coordinate system has two axes, longitude LO and latitude LA. In principle it does not matter whether the Universal Transverse Mercator (UTM) grid presents the intuitive geographic position.

The figure illustrates a discrete presentation of the coverage. Each of the coverage C1, . . . , C5 serves a set of fields. The field where the mobile M is located is shown by a bold face quadrate. And the relevant information for the retrieval method is that this field is served by C3, C2, and C5.

A simple form of the information system according to the invention might be realized as the following relational database schema:

### Coverage (Longitude, Latitude, Connection Type)

Longitude and Latitude model a Cartesian coordinate system, i.e. a simple topology (consisting of unions of grids). The connection type might be more complex, e.g. comprising technology, frequencies, calibration information, bandwidth, quality of service information, access node identifiers, handover control information etc.

For instance in figure two there are two types of access nodes, shown by different shapes, rectangles for UMTS, say, and diamonds for Bluetooth.

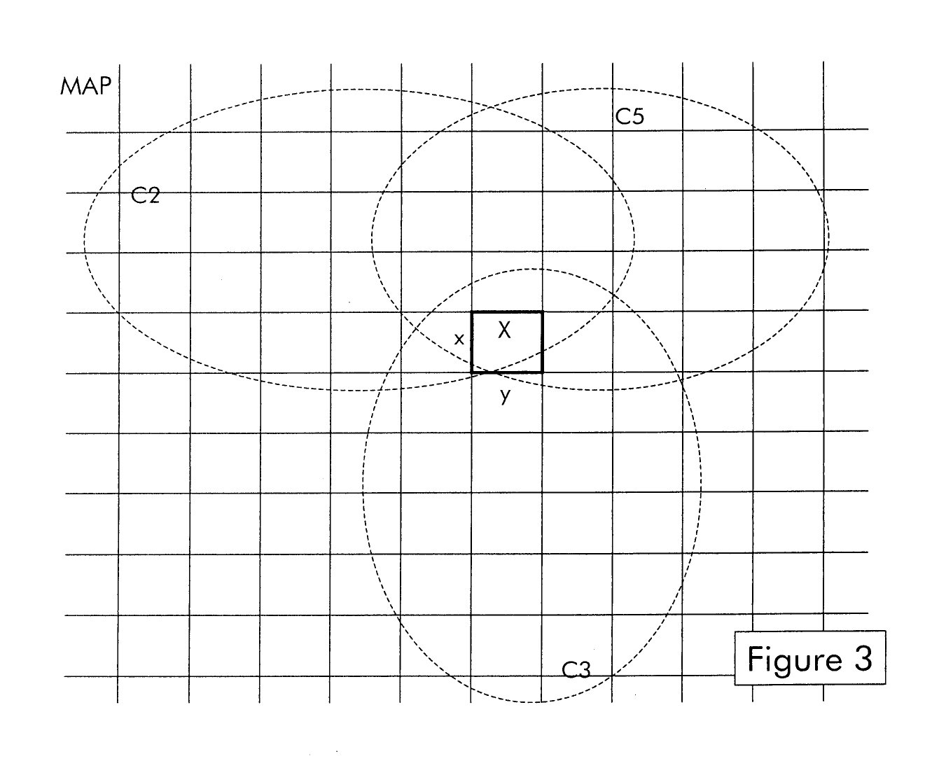

FIG. 3 shows the local relevant information MAP, i.e. the part of the information that is relevant for the field X where the mobile M is located.

A corresponding database cutout might be

| Longitude | Latitude | Connection Type |
|---|---|---|
| X.x | X.y | WiFi, N2 |
| X.x | X.y | WiMax, N5 |
| X.x | X.y | WiMax, N3 |

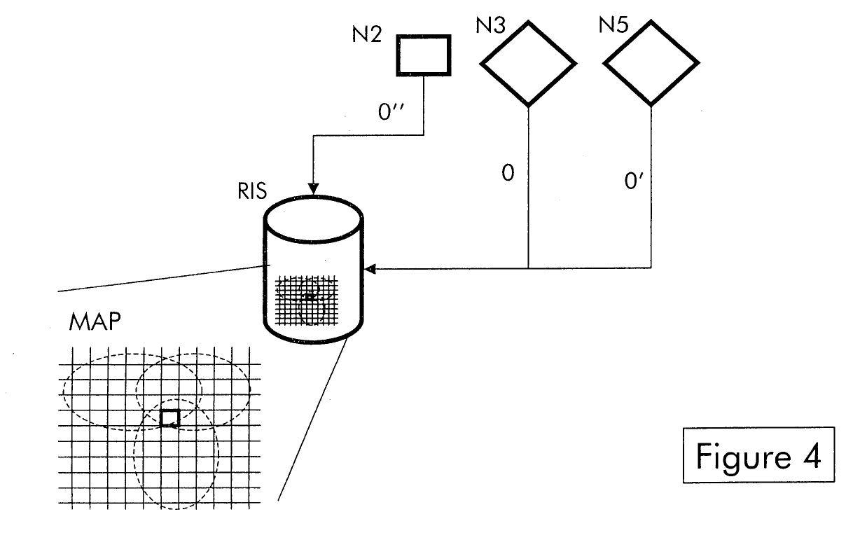

FIG. 4 illustrates the collaboration according to the method for providing within a telecommunication network available network connection types according to the invention, i.e., how the information comes into the database. Naturally this is either fixed information, e.g. provided by a network plan, or is even done by the access nodes dynamically, e.g. when they go online. This decreases heavily the maintenance efforts and increases the consistence of the information system. It further enables mobile access points. Whenever information of the access point changes e.g. its coverage e.g. by motion or by failure, the access point has to update, i.e. maintain the information system in order to keep the database integer and consistent.

The figure shows the three access nodes N2, N3, and N5 of the environment in focus and a database server RIS storing the local relevant information MAP. Each of the access nodes provides in an initial step 0, 0′, and 0″ its coverage and its connection type information.

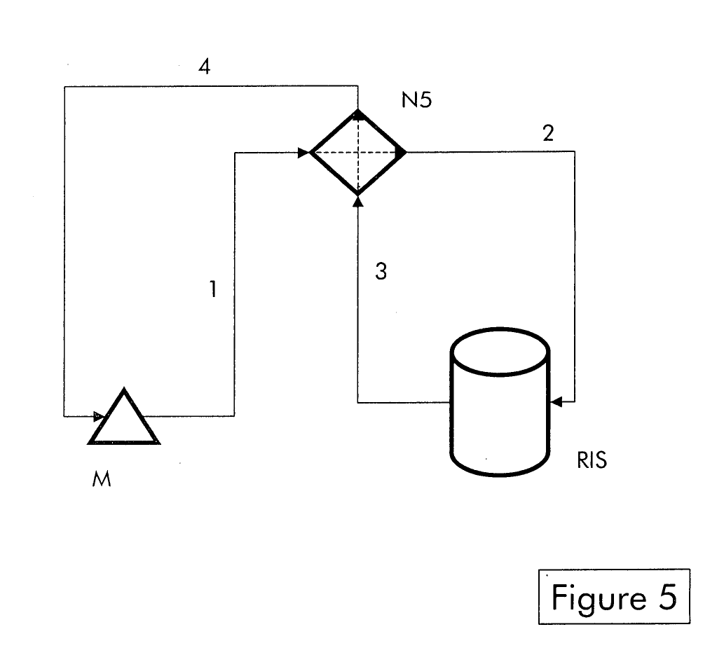

FIG. 5 illustrates the collaboration according to the method for retrieving within a telecommunication network available network connection types according to the invention. The mobile M requests the retrieval in a first step via an initial access node N5, say, by providing its position X. This access node forwards 2 the request to the information system RIS, or more specifically, to a responsible server of the information system. This server, i.e. the information system RIS replies 3 and 4 via the access node N5 with the available connection types at the mobile's position X to the mobile.

Afterwards the mobile has the information about all available connection types—even without scanning.

In a special implementation of this invention, the domain name system (DNS) might be used as database. The geographical position of the coverage, e.g. retrieved via GPS, might be converted into a domain name or into a set of domain names.

One possible example of such a conversion might be
UMT position North 49° 0′1″/East 9° 12′2″ into N.49.0.1.E.9.12.2 or into N.1.0.49.E.2.12.9 in order to support the identification search by providing most significant digits before less significant digits.

Similarly, two points could specify covered rectangles.

A terminal then can query with this domain name presenting the rectangle containing the rendered geographical position of the terminal. The domain name server then might return a list of resource records with the available (radio) technologies for the given geographical location.

Each record can contain different information fields like the radio technology, the used frequency bands and/or channels, the name of the network operator and other information. The DNS system can either be populated manually or automatically, where e.g. each access point fills in the data in the DNS system.

1. A method for retrieving within a telecommunication network available network connection types at a given location provided by access points by means of a telecommunication network device, wherein
the available network connection types at a given location are stored in an information system,
the telecommunication network device establishes at least one connection towards said information system, and
queries for information about available network connection types use the given location.

2. The method according to claim 1, wherein the information system is decomposed and the decomposition reflects the neighborhood, where the method comprises additionally the distribution of the query based on the given location.

3. The method according to claim 1, wherein the location is provided in uniform coordinates.

4. The method according to claim 3, wherein the location is mapped onto a domain name for identifying a connection type.

5. The method according to claim 1, wherein a connection type comprises an access technology.

6. The method according to claim 1, wherein a connection type comprises an access medium.

7. The method according to claim 1, wherein a connection type comprises an access point.

8. The method according to claim 1, wherein a connection type comprises coverage information.

9. A method for providing within a telecommunication network available network connection types at a given location provided by access points by means of a telecommunication network device, wherein an access point provides information about its coverage and its connection type in an information system for retrieving available network connection types.

10. An information system comprising a server, wherein said information system comprises means for storing information about available network connection types per location, for retrieving and providing within a telecommunication network available network connection types according to the method of claim 1 wherein an access point provides information about its coverage and its connection type.

11. A server as a part of an information system according to claim 10.

12. An access point providing within a telecommunication network available network connection types at a given location, wherein said access point comprises means for providing its coverage and its connection type to an information system for retrieving available network connection types.

13. A telecommunication device, wherein said telecommunication device comprises means for retrieving within a telecommunication network information about available network connection types according to claim 1.
